(19) United States
(12) Patent Application Publication
(10) Pub. No.: US 2025/0075359 A1
(43) Pub. Date: Mar. 6, 2025

(54) PREPARATION OF RARE EARTH METALS WITH DOUBLE SALTS

(71) Applicant: Iowa State University Research Foundation, Inc., Ames, IA (US)

(72) Inventors: Ikenna Cajetan Nlebedim, Ames, IA (US); Denis Prodius, Ames, IA (US); Anirudha Karati, Ames, IA (US); Harshida Parmar, Ames, IA (US); Trevor Riedemann, Ankeny, IA (US); Matthew Besser, Urbandale, IA (US)

(73) Assignee: Iowa State University Research Foundation, Inc., Ames, IA (US)

(21) Appl. No.: 18/818,176

(22) Filed: Aug. 28, 2024

Related U.S. Application Data
(60) Provisional application No. 63/579,454, filed on Aug. 29, 2023.

(51) Int. Cl. C25C 1/22

(52) U.S. Cl. CPC C25C 3/34; C22B 7/006; C22B 59/00

(57) ABSTRACT

Disclosed are embodiments of a method for producing a rare earth metal from a metallothermic reaction of a reductant metal and a double salt of the rare earth metal. The double salt of rare earth metal can be prepared from an alkali halide and a salt of the rare earth metal at room temperature over a time period of 2 hours of less without the requirement to use hydrofluoric acid.

### CROSS-REFERENCE TO RELATED PATENT APPLICATIONS

This patent application claims the benefit of U.S. Provisional Patent Application No. 63/579,454, filed Aug. 29, 2023., the entire teachings and disclosure of which are incorporated herein by reference thereto.

### STATEMENT REGARDING FEDERALLY SPONSORED RESEARCH AND DEVELOPMENT

This invention was made with government support under DE-AC02-07CH11358 awarded by the Department of Energy. The government has certain rights in the invention.

### FIELD OF THE INVENTION

This invention generally relates to preparation of rare earth metals and, in particular, to metallothermic reactions to isolate rare earth metals from double salts.

### BACKGROUND OF THE INVENTION

The increasing need to address critical materials challenges in key technologies, including for defense and energy security, has led to a significantly greater demand for production resources capable of using industrial-quality feedstock, including recycled feedstock, to produce rare earth (RE) metals. Metallothermic and electrolytic techniques have been utilized for producing RE metals.

In general, electrolytic reductions include either the decomposition of rare earth oxides (REO) dissolved in molten rare earth fluoride (REF) salts or the conversion of anhydrous RECl₃ dissolved in molten alkali metal salts or molten alkali. That is, in the molten salt electrolytic process, electricity is used to reduce REO into RE metal, as the REO is fed into a molten salt created with (typically) REX₃ and AX in which A is Li, Na, or K and X is For Cl. An advantage of electrolytic methods is that they can be semicontinuously run. Their disadvantages are the use of consumable and/or costly electrodes, the usage of anhydrous RE halides which require operation with hazardous acids and additional costs, energy-consuming cell operation, low current efficiencies, and low yield of recovered metal (≤50%).

The metallothermic processes include the reduction of REF₃ or REO with calcium (the calciothermic process) or other metals (e.g., Al, Li, Mg, La). To decrease the temperature of the reduction process, fluorides or chlorides of alkali metals are used as flux materials. Upon reaching high temperatures, these compounds melt and form a molten bath, which causes the reaction to proceed faster by lowering the net reaction temperature.

The Ames Process, developed by F. H. Spedding in 1959, is an example of the metallothermic reduction of anhydrous REF₃ to RE metal. Historically, Spedding designed a process by which pure uranium metal was obtained for the Manhattan Project according to Equation 1, below:

$${UF}_{4} + 2 Ca \to U + 2 {CaF}_{2} + Δ H ( heat ) \qquad ( 1 )$$

This is a typical example of the thermite reaction which, when ignited by heat (<300° C.) or chemical reaction (e.g., Mg ribbon-like fuse, 1:1 mix of Ca/FeF₃, etc.), undergoes an exothermic redox process. Progressing the reaction to a temperature higher than the melting point of all components will result in slag/metal gravity separation. The exothermicity of this process is a key point and a substantial advantage for power cost savings as compared to the electrolytic processes. The reduction reaction is quick and lasts minutes. The generated slag containing CaF₂ will protect the metal formed from substantial oxidation. An advantage of metallothermic reduction is a high recovery yield (>90%) and energy-efficient conditions.

Both the metallothermic and electrolytic processes require the use of RE halides, in particular REF₃. However, the difficulty and hazards of using HF to produce the fluorides (e.g., according to the equation RE₂O₃+6HF→2REF₃+3H₂O) for these processes presents a significant challenge. Consequently, calciothermic reduction process, which relies mostly on REF₃ as the feedstock, is nearly reserved to small-scale production of heavy RE. The electrolytic process is now evaluating the use RECl₃, despite the difficulties posed by the high hygroscopic nature of RECl₃ (including low yield), compared to REF₃.

Still, the deficiency of environmentally friendly (i.e., without use of HF or other hazards), technically straightforward (e.g., room temperature operations with standard laboratory equipment), and commercially non-expensive technology for anhydrous REF₃ preparation creates a considerable technical gap in the RE metal production chain. Additionally, industrial application of the existing version of the Ames Process for RE metal reduction is not viable. Other disadvantages of this approach are the utilization of anhydrous RE halides and serious technical challenges related to their preparation (a batch process that should be performed in a non-oxidizing atmosphere).

### BRIEF SUMMARY OF THE INVENTION

Applicant has recognized a need for a feedstock for the production of RE metal that neither requires HF for its production nor generates HF as a byproduct; that may eliminate or require less addition of AX to REX₃ (A=Li, Na, or K and X=F or Cl) to create a molten salt at <1000° C.; that can serve both for metallothermic and electrolytic processes; and that can be prepared at room temperature without the need for inert environment. According to embodiments of the present disclosure, Applicant has found that double salts of the form AₓRE_{y}X_{z}, in which A is Li, Na, or K and X is F, Cl, or Br, are suitable for producing RE metal in a manner that addresses the needs in the art.

In a first aspect, embodiments of the present disclosure relate to a method of producing rare earth (RE) metal. In the method, an alkali-halide double salt of the RE metal is reacted with a reductant metal to produce RE metal, a halide of the reductant metal, and alkali halide.

In a second aspect, embodiments of the present disclosure relate to the method of the first aspect in which the alkali-halide double salt of the RE metal comprises an alkali selected from the group consisting of lithium, sodium, potassium, and combinations thereof.

In a third aspect, embodiments of the present disclosure relate to the method of the first aspect or the second aspect in which the alkali-halide double salt comprises a halide selected from the group consisting of fluorine, chlorine, bromine, and combinations thereof.

In a fourth aspect, embodiments of the present disclosure relate to the method of any of the first aspect to the third aspect in which the alkali halide double salt of the RE metal has the form of AₓRE_{y}X_{z} in which A is selected from the group consisting of Li, Na, K, and combinations thereof and X is selected from the group consisting of F, Cl, Br, and combinations thereof.

In a fifth aspect, embodiments of the present disclosure relate to the method of the fourth aspect in which x is in a range from 0.15 to 4, y is in a range from 0.5 to 3, and z is in a range from 4 to 10.

In a sixth aspect, embodiments of the present disclosure relate to the method of any of the first aspect to the fifth aspect in which the RE metal is selected from a group consisting of scandium, yttrium, lanthanum, cerium, praseodymium, neodymium, promethium, samarium, europium, gadolinium, terbium, dysprosium, holmium, erbium, thulium, ytterbium, lutetium, and combinations thereof.

In a seventh aspect, embodiments of the present disclosure relate to the method of any of the first aspect to the sixth aspect in which the method further comprises mixing a first aqueous solution comprising an RE salt and a second aqueous solution comprising an alkali-halide salt to form a mixture and separating the alkali-halide double salt of the RE metal that precipitates from the mixture.

In an eighth aspect, embodiments of the present disclosure relate to the method of the seventh aspect in which the RE salt is selected from a group consisting of chlorides, nitrates, acetates, oxalates, carbonates, phosphates, sulphates, and combinations thereof.

In a ninth aspect, embodiments of the present disclosure relate to the method of the seventh aspect or the eighth aspect in which the mixing and separating takes place at room temperature.

In a tenth aspect, embodiments of the present disclosure relate to the method of any of the first aspect to the tenth aspect in which reacting comprises heating the alkali-halide double salt of the RE metal and the reductant metal.

In an eleventh aspect, embodiments of the present disclosure relate to the method of any of the first aspect to the fourteenth aspect in which the reductant metal is selected from a group consisting of calcium, aluminum, magnesium, lanthanum, and combinations thereof.

In a twelfth aspect, embodiments of the present disclosure relate to a method of producing rare earth (RE) metal. In the method, an alkali-halide double salt of the RE metal is electrolytically reacted with at least one of an RE oxide or an RE halide to produce RE metal under flux in an electrolytic cell.

In a thirteenth aspect, embodiments of the present disclosure relate to the method according to the twelfth aspect in which the alkali halide double salt of the RE metal has the form of AₓRE_{y}X_{z}, in which A is selected from the group consisting of Li, Na, K, and combinations thereof, and in which X is selected from the group consisting of F, Cl, Br, and combinations thereof.

In a fourteenth aspect, embodiments of the present disclosure relate to the method according to the twelfth aspect or the thirteenth aspect in which the RE metal is selected from a group consisting of scandium, yttrium, lanthanum, cerium, praseodymium, neodymium, promethium, samarium, europium, gadolinium, terbium, dysprosium, holmium, erbium, thulium, ytterbium, lutetium, and combinations thereof.

In a fifteenth aspect, embodiments of the present disclosure relate to the method according to any of the twelfth aspect to the fourteenth aspect in which the method further comprises utilizing a consumable anode during the electrolytically reacting.

In a sixteenth aspect, embodiments of the present disclosure relate to the method according to any of the twelfth aspect to the fourteenth aspect in which the method further comprises utilizing a non-consumable anode during the electrolytically reacting.

In a seventeenth aspect, embodiments of the present disclosure relate to a method of extracting rare earth (RE) metal. In the method, a first aqueous solution comprising an RE salt and a second aqueous solution comprising an alkali-halide salt are mixed to form a mixture. An alkali-halide double salt of the RE metal is precipitated and has the form of AₓRE_{y}X_{z}, in which A is an alkali metal and X is a halide. The alkali-halide double salt of the RE metal that precipitates from the mixture is separated. The alkali-halide double salt of the RE metal is electrolytically or metallothermically reacted to obtain the RE metal.

In an eighteenth aspect, embodiments of the present disclosure relate to the method of the seventeenth aspect in which x is in a range from 0.15 to 4, y is in a range from 0.5 to 3, and z is in a range from 4 to 10.

In a nineteenth aspect, embodiments of the present disclosure relate to the method of the seventeenth aspect or the eighteenth aspect in which A is selected from a group consisting of Li, Na, K, and combinations thereof, in which X is selected from a group consisting of F, Cl, Br, and combinations thereof, and in which the reductant metal is selected from a group consisting of calcium, aluminum, magnesium, lanthanum, and combinations thereof.

In a twentieth aspect, embodiments of the present disclosure relate to the method of any of the seventeenth aspect to the nineteenth aspect in which the RE salt is selected from a group consisting of chlorides, nitrates, acetates, oxalates, carbonates, phosphates, sulphates, and combinations thereof.

In a twenty-first aspect, embodiments of the present disclosure relate to the method of any of the seventeenth aspect to the twentieth aspect in which the RE metal is selected from a group consisting of scandium, yttrium, lanthanum, cerium, praseodymium, neodymium, promethium, samarium, europium, gadolinium, terbium, dysprosium, holmium, erbium, thulium, ytterbium, lutetium, and combinations thereof.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an x-ray diffraction (XRD) pattern of sodium-rare earth-fluoride double salt Na_{0.76}Nd_{1.75}F₆·XH₂O, according to an exemplary embodiment;

FIG. 2 is a thermogravimetry/differential scanning calorimetry (TG-DSC) plot of mass changes of the sodium-rare earth-fluoride double salt as a function of temperature, according to an exemplary embodiment;

FIG. 3 is an XRD pattern of neodymium metal isolated from the sodium-rare earth-fluoride double salt along with a neodymium metal XRD reference pattern, according to an exemplary embodiment; and

FIG. 4 is a TG-DSC plot of the neodymium metal isolated from the sodium-rare earth-fluoride double salt, including an inset picture of Nd metal from the TG-DSC analysis, according to an exemplary embodiment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

According to embodiments of the presently disclosed methods, rare earth (RE) metal is produced from a double salt of the RE metal in a metallothermic or electrolytic reaction. In particular, a salt of RE metal is converted to an alkali-halide (A-X) double salt of the rare earth metal (A-RE-X) using A-X salt under specific conditions. In one or more embodiments, the RE metal is at least one of scandium, yttrium, lanthanum, cerium, praseodymium, neodymium, promethium, samarium, europium, gadolinium, terbium, dysprosium, holmium, erbium, thulium, ytterbium, or lutetium. In one or more embodiments, the alkali metal (A) is one or more of Li, Na, or K. In one or more embodiments, the halide (X) is one or more of F, Cl, or Br.

According to a first aspect, the double salt A-RE-X is reacted with a metal reductant, such as calcium (Ca), aluminum (Al), magnesium (Mg), or lanthanum (La), in a metallothermic reaction. In one or more embodiments, the double salt A-RE-X and reductant metal are reacted in a sealed vessel. In one or more embodiments, the reaction takes place in a refractory tube, such as a quartz tube. For example, the tube may include the double salt A-RE-X and calcium and be sealed under argon gas. In one or more embodiments, the tube may be heated using plasma induction. In another example, the reaction may take place in a vacuum furnace, e.g., at a vacuum of 10-1 Torr. In still one or more other embodiments, the heating takes place in a normal atmosphere (i.e., in air at standard pressure), especially where the double salt A-RE-X is a molten salt and/or the metallothermic reaction produces slag that may protect the reactants during reduction.

In one or more embodiments, the RE metal is converted to a double salt of the form AₓRE_{y}X_{z} in which x is in a range from 0.15 to 4, y is in a range from 0.5 to 3, and z is in a range from 4 to 10. The inclusion of the alkali metal (including Na, Li, and/or K) in the compound helps in reducing the melting point of the compound. In one or more embodiments, metallothermic reduction can be used to produce RE metal according to Equation 2 in which RM represents the reductant metal.

$${A}_{x} {RE}_{y} {X}_{z} + wRM \to {yRE}^{0} + xAX + {wRMX}_{( 2 or 3 )} + Δ H ( heat ) \qquad ( 2 )$$

According to a second aspect, the low melting point double salt AₓRE_{y}X_{z} as described above is reacted with at least one of an RE oxide (RE₂O₃) or an RE halide (REX₃) in an electrolytic cell in the presence of a molten salt flux. In one or more embodiments, the electrolytic cell includes consumable anodes, such as carbon (in particular, graphite) anodes. In one or more other embodiments, the anodes are not consumable, such as anodes formed from metal alloys. In such embodiments, the reduced melting point double salt compound can be used in an electrolytic cell containing a molten salt to reduce RE₂O₃ or REX₃ to metal using consumable electrode according to Equation 3 or non-consumable electrode according to Equation 4.

$$2 C ( anode ) + {RE}_{2} {O}_{3} ( or 2 {REX}_{3} ) + \{ {A}_{x} {RE}_{y} {X}_{z} + flux \} \to 2 {RE}^{0} + ( CO ↑ + {CO}_{2} ↑ ) ( or C - X compounds ) + \{ {A}_{x} {RE}_{y} {X}_{z} + flux \} \qquad ( 3 )$$

$$2 {RE}_{2} {O}_{3} ( or 4 {REX}_{3} ) + \{ {A}_{x} {RE}_{y} {X}_{z} + flux \} \to 4 {RE}^{0} + 3 {O}_{2} ↑ ( or 6 {X}_{2} ↑ ) + \{ {A}_{x} {RE}_{y} {X}_{z} + flux \} \qquad ( 4 )$$

According to the proposed processes, the A-RE-X double salt can be prepared from a wide range of RE starting salts, such as chlorides, nitrates, acetates, oxalates, carbonates, phosphates, and sulphates. That is, non-limiting examples of the salt of the rare earth metal that is converted to an A-X double salt include RE chlorides, RE nitrates, RE acetates, RE oxalates, RE carbonates, RE phosphates, or RE sulphates, among other possibilities.

The RE starting salt is dissolved in a first aqueous solution, and the A-X salt is dissolved in a second aqueous solution. In one or more embodiments, the first aqueous solution is added to the second aqueous solution, and in one or more embodiments, the second aqueous solution is added to the first aqueous solution. In one or more embodiments, the aqueous solution having the lower concentration of salt is added to the aqueous solution having the higher concentration of salt. In one or more embodiments, the RE salt aqueous solution and the A-X salt aqueous solution are mixed at room temperature. In one or more embodiments, one aqueous salt solution is added dropwise to the other aqueous salt solution. In one or more embodiments, the aqueous solution of RE salt is mixed with the aqueous solution of A-X salt at a ratio of 1 part RE salt to at least 4 parts A-X salt. The solutions may be mixed using constant stirring over a time period of 0.5 hours to 5 hours, in particular about 1 hour to about 2 hours.

Over time, the A-RE-X double salt will precipitate from solution, and the A-RE-X double salt can be separated (e.g., by decantation). Thereafter, the A-RE-X double salt may be dried and may then be used in the metallothermic process described above in Equation 2. Double salts produced according to the present disclosure may have a variety of forms, such as AREX₄, A₃REX₆, and A₂REX₅, among others, that are suitable for use in the metallothermic process.

Applicant expects that the presence of alkali metal in the rare earth halide can reduce the temperature of the reaction (metallothermic or electrolytic) in addition to lowering the carbon footprint and usage of toxic acids (such as HF). Specifically, the presently disclosed process is expected to have a lower carbon footprint than existing metallothermic and electrolytic processes in which rare earth oxides are produced from rare earth chlorides, nitrates, oxalates, carbonates, or phosphates and in which rare earth fluorides are produced from HF. Further, the disclosed process does not involve the usage of harmful HF for the synthesis of fluorides. Additionally, the synthesis of A-RE-X, such as Na-RE-F, can be carried out at room temperature with relatively short reaction times, such as 1 hour or less.

### EXAMPLES

### Example 1-Synthesis of Sodium Rare-Earth Fluoride from Rare-Earth Acetate

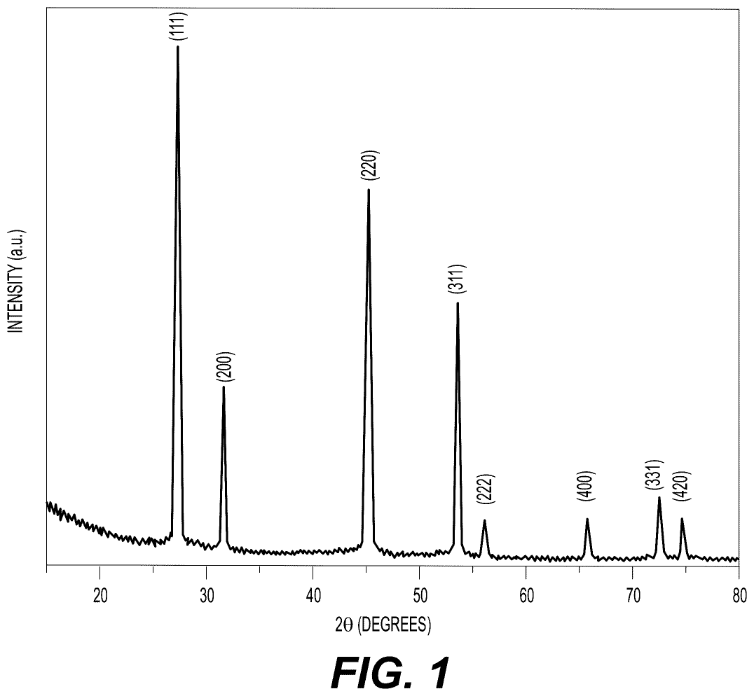

A first solution of neodymium (III) acetate was dissolved in water. A second solution of sodium fluoride was dissolved in water. In this example, the first solution was gently added to the second solution under vigorous stirring (however, as discussed above, the second solution may instead be added to the first solution). A purple precipitate started to form. The reaction was allowed to proceed at room temperature while continuing to stir. The contents were carefully decanted, and the precipitate was allowed to dry in a hot air oven. The x-ray diffraction (XRD) pattern for the dried precipitate is provided in FIG. 1. The XRD pattern is consistent with the presence of a major phase of Na_{0.76}Nd_{1.75}F₆·XH₂O as found in literature.

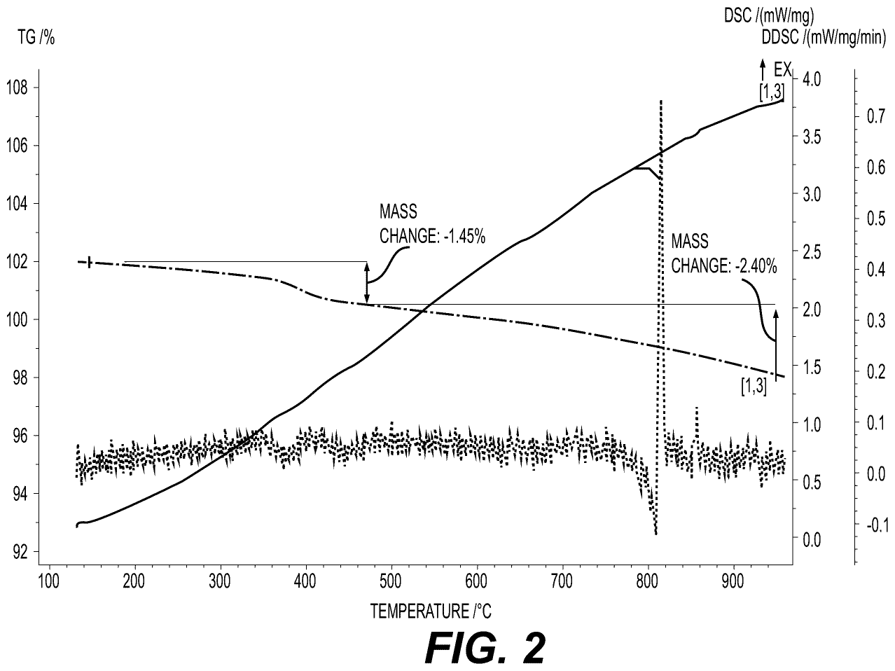

The thermogravimetry-differential scanning calorimetry (TG-DSC) plot of the synthesized Na—Nd—F is provided in FIG. 2. As can be seen from FIG. 2, the synthesized Na—Nd—F demonstrated an endothermic melting peak at 750° C. The net mass loss was 1.45% at 480° C. and 2.4% at 950° C. These characteristics are consistent with rare earth fluorides synthesized using standard synthetic protocols (e.g., using HF and NH₄HF₂).

### Example 2-Synthesis of Rare-Earth Metal Using Calciothermic Reduction

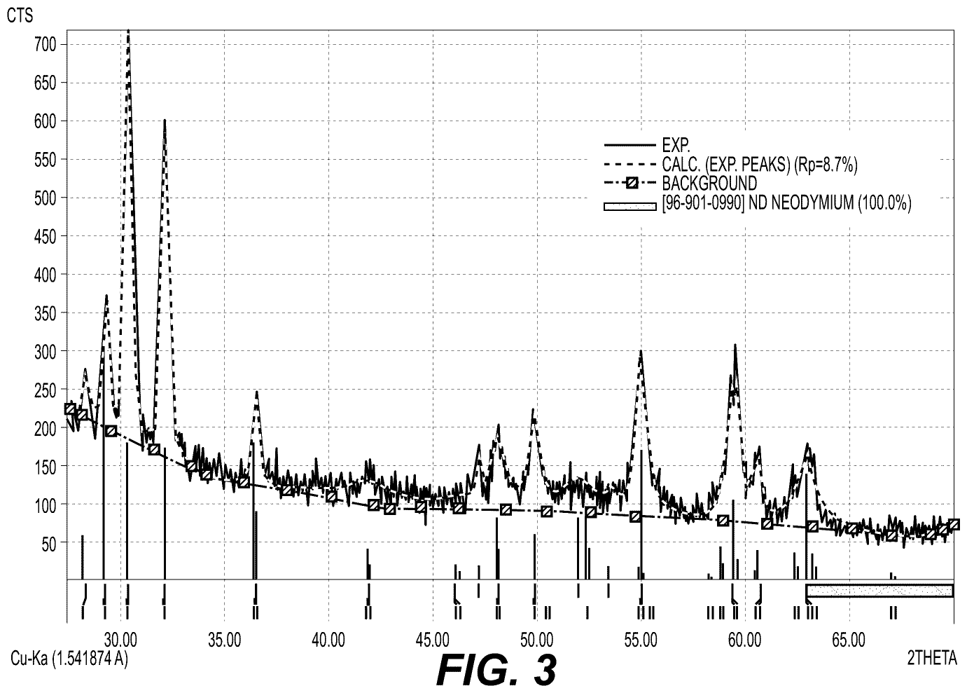

From the Na—Nd—F double salt prepared in Example 1, Na_{0.76}Nd_{1.75}F₆ was packed with pure calcium in a quartz tube, and the contents were sealed under argon. Using plasma induction, the contents were melted for 1 hour. Gravity separated the reaction products with flux (NaF and CaF₂) floating to the top of the tube where it could be removed as slag upon solidification. The remaining neodymium metal was subjected to XRD spectroscopy, and the resulting XRD pattern is provided in FIG. 3. As can be seen, the experimentally determined peaks correspond to the reference XRD pattern for neodymium metal.

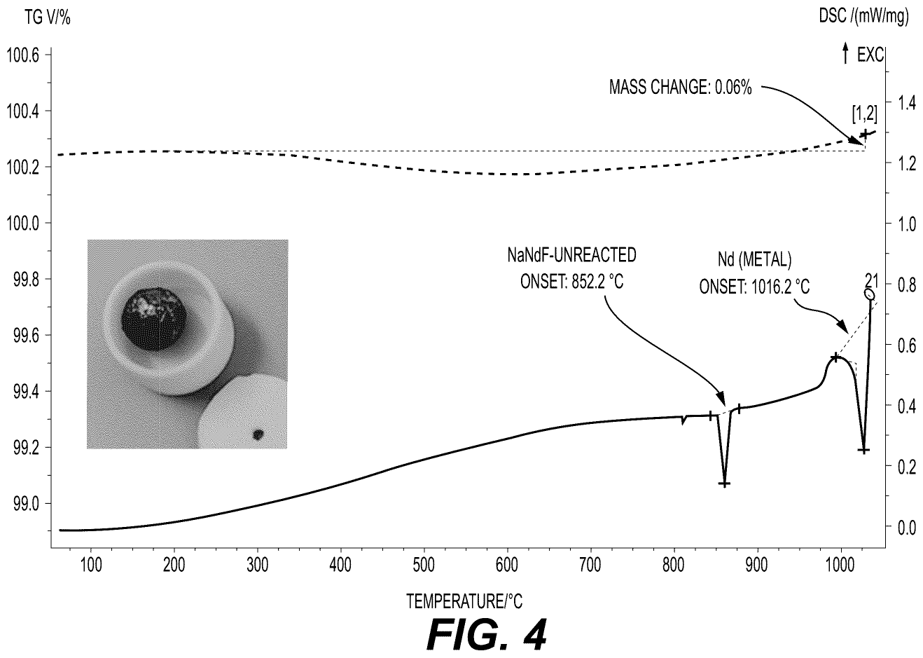

The recovered neodymium metal was subjected to TG-DSC testing with the results provided in FIG. 4. As can be seen in FIG. 4, the recovered neodymium metal exhibited a melting point of about 1016° C., which is consistent with the melting temperature of neodymium metal found in literature. The ball of neodymium metal produced in Example 2 can be seen in the figure inset of FIG. 4.

The recovered neodymium metal was also analyzed to determine the presence of carbon, nitrogen, oxygen, and sulfur impurities. The estimated concentration of such impurities was 145±45 ppm C, 49±3 ppm N, 823±94 ppm O, and <1 ppm S. Thus, each individual impurity was present at a level of 1000 ppm or less, and collectively, the impurities were together at a level of 2000 ppm or less.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of producing rare earth (RE) metal, comprising:
reacting an alkali-halide double salt of the RE metal with a reductant metal to produce RE metal, a halide of the reductant metal, and alkali halide.

2. The method of claim 1, wherein the alkali-halide double salt of the RE metal comprises an alkali selected from the group consisting of lithium, sodium, potassium, and combinations thereof.

3. The method of claim 1, wherein the alkali-halide double salt comprises a halide selected from the group consisting of fluorine, chlorine, bromine, and combinations thereof.

4. The method of claim 1, wherein the alkali halide double salt of the RE metal has the form of AₓRE_{y}X_{z} in which A is selected from the group consisting of Li, Na, K, and combinations thereof and X is selected from the group consisting of F, Cl, Br, and combinations thereof.

5. The method of claim 4, wherein x is in a range from 0.15 to 4, y is in a range from 0.5 to 3, and z is in a range from 4 to 10.

6. The method of claim 1, wherein the RE metal is selected from a group consisting of scandium, yttrium, lanthanum, cerium, praseodymium, neodymium, promethium, samarium, europium, gadolinium, terbium, dysprosium, holmium, erbium, thulium, ytterbium, lutetium, and combinations thereof.

7. The method of claim 1, further comprising:
mixing a first aqueous solution comprising an RE salt and a second aqueous solution comprising an alkali-halide salt to form a mixture;
separating the alkali-halide double salt of the RE metal that precipitates from the mixture.

8. The method of claim 7, wherein the RE salt is selected from a group consisting of chlorides, nitrates, acetates, oxalates, carbonates, phosphates, sulphates, and combinations thereof.

9. The method of claim 7, wherein the mixing and separating takes place at room temperature.

10. The method of claim 1, wherein the RE metal gravimetrically separates from the halide of the reductant metal and alkali halide.

11. The method of claim 1, wherein the reductant metal is selected from a group consisting of calcium, aluminum, magnesium, lanthanum, and combinations thereof.

12. A method of producing rare earth (RE) metal, comprising:
electrolytically reacting an alkali-halide double salt of the RE metal with at least one of an RE oxide or an RE halide to produce RE metal under flux in an electrolytic cell.

13. The method according to claim 12, wherein the alkali halide double salt of the RE metal has the form of AₓRE_{y}X_{z} in which A is selected from the group consisting of Li, Na, K, and combinations thereof and X is selected from the group consisting of F, Cl, Br, and combinations thereof.

14. The method according to claim 12, wherein the RE metal is selected from a group consisting of scandium, yttrium, lanthanum, cerium, praseodymium, neodymium, promethium, samarium, europium, gadolinium, terbium, dysprosium, holmium, erbium, thulium, ytterbium, lutetium, and combinations thereof.

15. The method according to claim 12, further comprising utilizing a consumable anode during the electrolytically reacting.

16. The method according to claim 12, further comprising utilizing a non-consumable anode during the electrolytically reacting.

17. A method of extracting rare earth (RE) metal, comprising:
mixing a first aqueous solution comprising an RE salt and a second aqueous solution comprising an alkali-halide salt to form a mixture;
precipitating an alkali-halide double salt of the RE metal having the form of AₓRE_{y}X_{z}, in which A is an alkali metal and X is a halide;
separating the alkali-halide double salt of the RE metal that precipitates from the mixture; and
electrolytically or metallothermically reacting the alkali-halide double salt of the RE metal to obtain the RE metal.

18. The method of claim 17, wherein x is in a range from 0.15 to 4, y is in a range from 0.5 to 3, and z is in a range from 4 to 10.

19. The method of claim 17, wherein A is selected from a group consisting of Li, Na, K, and combinations thereof, wherein X is selected from a group consisting of F, Cl, Br, and combinations thereof, and wherein the reductant metal is selected from a group consisting of calcium, aluminum, magnesium, lanthanum, and combinations thereof.

20. The method of claim 17, wherein the RE salt is selected from a group consisting of chlorides, nitrates, acetates, oxalates, carbonates, phosphates, sulphates, and combinations thereof.

21. The method of claim 17, wherein the RE metal is selected from a group consisting of scandium, yttrium, lanthanum, cerium, praseodymium, neodymium, promethium, samarium, europium, gadolinium, terbium, dysprosium, holmium, erbium, thulium, ytterbium, lutetium, and combinations thereof.
